(19) United States
(12) Patent Application Publication
(10) Pub. No.: US 2005/0002729 A1
(43) Pub. Date: Jan. 6, 2005

(54) Fastening device for modular structures, in particular tables, desks, shelves, fitting-carrying walls

(75) Inventor: Bruno Nicoletti, Calderino di Monte S. Pietro (IT)

Correspondence Address: WILLIAM J. SAPONE;COLEMAN SUDOL SAPONE P.C., 714 COLORADO AVENUE, BRIDGE PORT, CT, 06605, US

(73) Assignee: METAL WORK S.r.I., Calderino di Monte S. Pietro (IT)

(21) Appl. No.: 10/881,836

(22) Filed: Jun. 30, 2004

(30) Foreign Application Priority Data
Jul. 3, 2003 (IT) BO2003A 000412

(51) Int. Cl. F16B 9/00

(52) U.S. Cl. 403/253

(57) ABSTRACT

In a fastening device for modular structures includes, a first modular element has at least one longitudinal groove receiving, in a free coupling, one slide. The slide carries a second modular element and is fixed at a position within the longitudinal groove by abutment blocks locked by fixing screw-dowels.

### BACKGROUND OF THE INVENTION

The present invention relates to the production of pieces of furniture, mainly for offices or other professional premises.

In particular, the present invention refers to a fastening device for modular structures, such as desks, tables, shelves, fitting-carrying walls and the like.

### DESCRIPTION OF THE PRIOR ART

The furniture industry produces generally modular structures, which not only permit configurations in relation to different needs, but they can be also easily transported to the installation place and then assembled there in a simple, rapid and stable way, without any difficulty.

There are known many systems for mutual fastening of the elements of the pieces of furniture structures.

According to some known fastening systems, notches are made on the structure elements, which allow to match the elements with one another. The joined elements are then definitively fastened by screws or similar means, also with the help of suitably prepared holes.

According to other known fastening systems, internally threaded sleeves are introduced into suitable seats made in correspondence to the ends of a first series of elements, aimed at coupling reciprocally.

The elements of a second series include holes, inside which the screws are introduced, to engage with the threaded sleeves.

The modular structures can assume different configurations in relation to different needs and they can be also packaged in not particularly big packs, so they can be easily transported to the installation place and then assembled there.

However, the fastening elements of such structures have different disadvantages, such as insufficient stability and/or rigidity of the mutual joints between various structural elements, complexity of the operations necessary to complete their assemblage, as well as a considerable amount of time necessary for the assemblage operation.

These fastening systems can often render the so obtained modular structure not perfectly equilibrated and not wholly stable in the joints and connections.

### SUMMARY OF THE INVENTION

The object of the present invention is to propose a fastening device for modular structures, in particular desks, tables, shelves, fitting-carrying walls and the like, which needs a limited number of elements and allows an easy and simple connection by any assembler, even if the desired furniture structures are complicated.

Another object of the present invention is to propose a fastening device for modular structures of furniture, which gives stable and strong connections, whose preparation requires much less time than the conventional known systems.

A further object of the present invention is to propose a fastening device, which ensures a high strength standard and sufficiently limited production costs.

The above mentioned objects are obtained, in accordance with the contents of the claims, by means of a fastening device for modular structures, such as tables, desks, shelves, fitting-carrying walls, including:
a first modular element having at least one longitudinal groove for receiving, in a free coupling, at least one slide;
a second modular element removably connected to said slide;
abutment means introduced within said longitudinal groove for defining a position of said slide with respect to said longitudinal groove;
fixing means cooperating with said abutment means for firmly fixing said position of said slide within said longitudinal groove to lock said slide.

### BRIEF DESCRIPTION OF THE DRAWINGS

The characteristic features of the invention will be pointed out in the following description of a preferred embodiment, with reference to the enclosed drawings, in which:

FIG. 1 is a schematic lateral, partially cross-sectional view of the most significant elements of the proposed fastening device during an assembling stage;

FIG. 2 is a schematic section view, taken along line II-II indicated in FIG. 1;

FIG. 3 is a schematic, partially cross-sectional side view of the proposed fastening device in assembled configuration;

FIG. 4 is a schematic top view of the proposed fastening device in assembled configuration.

### DESCRIPTION OF THE PREFERRED EMBODIMENT

With reference to the above drawings, reference numeral 1 generally indicates the proposed fastening device for modular structures, in particular tables, desks, shelves, fitting-carrying walls and the like, substantially including a first modular element 3, for example an upright, having at least one longitudinal groove 30, aimed at receiving in free coupling a slide 5, which carries, removable in a known way, a second modular element 4, for example a longitudinal bar.

With reference to FIGS. 2 and 4, the cross-section of the longitudinal groove 30 forms preferably an isosceles trapezium, open in the shorter base and guiding the slide 5 along the longer base.

The fastening device 1, proposed by the present invention, includes also abutment means, which enter the longitudinal groove 30, so as to lock firmly the configuration of the slide 5 with respect to the longitudinal groove 30.

The abutment means cooperate with fixing means 7, which fix the latter inside the longitudinal groove 30, so as to facilitate the tightening and blocking of the slide 5.

Advantageously, the abutment means include a pair of small blocks, namely a first block 6a and a second block 6b, which mate with the upper end 5a and at the lower end 5b of the slide 5.

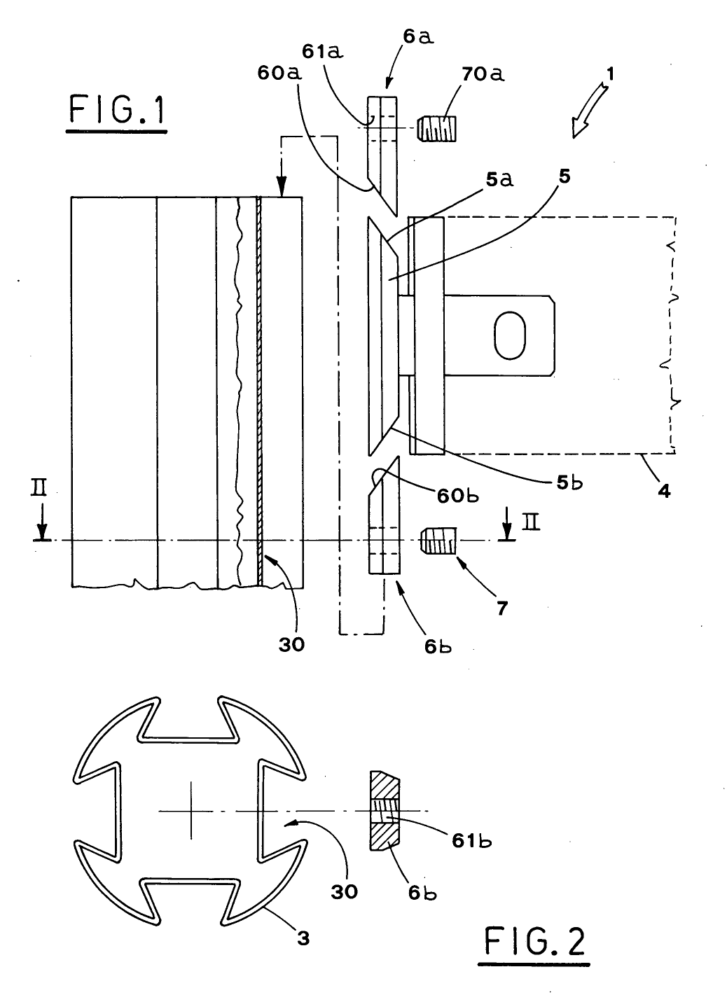

As it appears clearly from FIG. 1, each of the small blocks 6a, 6b, has an inclined portion 60a, 60b, which goes in abutment against the corresponding end 5a, 5b, likewise inclined, of the guide 5.

According to a preferred embodiment, the fixing means 7 include threaded dowels 70a, 70b, or screws, which engage with corresponding through holes 61a, 61b, made in the pair of small blocks 6a, 6b, on the part opposite to the inclined portions 60a, 60b.

Obviously, the inclination angle of the portions 60a, 60b of the small blocks 6a, 6b can be equal to, smaller than, or bigger than the inclination angle of the inclined portions of the ends 5a, 5b of the slide 5.

In particular, the portions 60a, 60b of the small blocks 6a, 6b, as well as the corresponding ends 5a, 5b of the guide 5, have the form of a wedge.

Now, assembling of the fastening device 1 proposed by the present invention will be described briefly.

First, the second small block 6b is introduced into the open end, e.g. upper, of the longitudinal groove 30 up to the desired depth, where it is blocked, by engaging in a known way, of the corresponding threaded dowels 70b with the through hole 61b.

After the second small block 6b has been fastened, the guide 5 is introduced freely into the longitudinal groove 30, in such a way that the inclined portion of the lower end 5b of the slide 5 goes in abutment against the corresponding inclined portion of the second block 6b, having opposite inclination.

In this case, it is preferred that the inclinations of the corresponding wedges, 5b of the slide 5 and 60b of the second small block 6b be oriented in such a way that, after the wedges have gone in mutual abutment, the slide 5 is pushed against the bottom, that is the longer base of the longitudinal groove 30, having the isosceles trapezium shaped cross-section (FIG. 4).

When the slide 5 is positioned inside the groove 30, with the lower end 5b correctly in abutment against the second small block 6b, the first small block 6a is introduced into the groove 30, until the corresponding wedge-like inclined surfaces, formed by the upper end 5a of the slide 5 and of the first small block 6a, go in mutual abutment.

When the first small block 6a has gone in abutment against the upper end 5a of the slide 5, the first small block 6a is fixed, by engaging of the corresponding threaded dowel 70a with the through hole 61a.

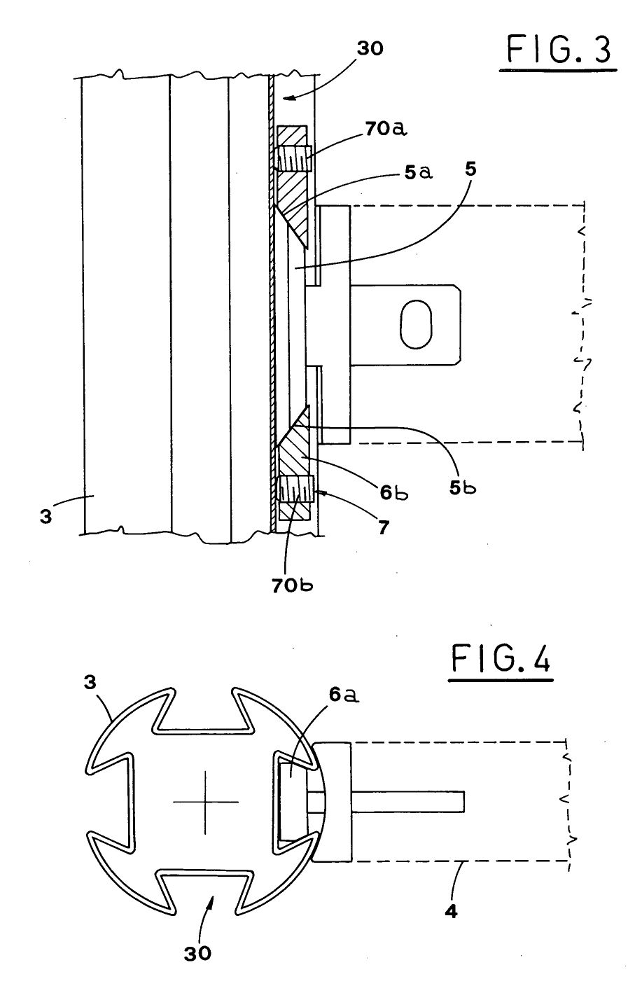

FIGS. 3 and 4 show the proposed fastening device 1 in an assembled configuration, with the slide 5 firmly pushed against the bottom of the longitudinal groove 30, that is against the longer base of the isosceles trapezium.

It is understood, and thus not shown, that what described above, can be applied also if the upright 3 has two, or three, or four longitudinal grooves 30, aimed at receiving corresponding slides 5 in free coupling.

The proposed fastening device for modular structures, particularly indicated for desks, tables, shelves, fitting-carrying walls and the like, requires the use of a limited number of elements and allows an easy and simple connection by any assembler, even if the desired furniture structures are complicated.

In spite of the extreme assembling simplicity, the obtained modular structures allow to produce stable and particularly strong connections, whose preparation requires much less time with respect to the traditional known systems.

Therefore, any variation and/or modification of the configuration of the modular structure is particularly simple and rapid, which reduces time necessary for the assembling and interventions.

It is understood that what above has been described with reference to the enclosed drawings as a pure, not limiting example. Therefore, all possible changes and variants of the invention remain within the protective scope of the present technical solution, as described above and claimed below.

1. A fastening device for modular structures, such as tables, desks, shelves, fitting-carrying walls, including:
a first modular element having at least one longitudinal groove for receiving, in a free coupling, at least one slide;
a second modular element removably connected to said slide;
abutment means introduced within said longitudinal groove for defining a position of said slide with respect to said longitudinal groove;
fixing means cooperating with said abutment means for firmly fixing said position of said slide within said longitudinal groove to lock said slide.

2. A device as claimed in claim 1, wherein said abutment means include a pair of small blocks, a first block and a second block set in abutment against an upper end and a lower end respectively of said slide, with at least one of the said small blocks provided with an inclined portion for abutting against a corresponding likewise inclined end of said slide for firmly fixing said slide within the longitudinal groove.

3. A device as claimed in claim 2, wherein each of said small blocks has an inclined portion for going in abutment against a corresponding likewise inclined end of said slide.

4. A device as claimed in claim 3, wherein said fixing means include threaded dowels, or screws, engaging with corresponding through holes made in said small blocks on a part opposite to said inclined portions.

5. A device as claimed in claim 2, wherein said portions of said small blocks have an inclination angle equal to, smaller, bigger than an inclination angle of the inclined portions of the corresponding ends of said slide 5.

6. A device as claimed in claim 2, wherein said portions of said small blocks and the corresponding ends of said slide have a wedge form.

7. A device as claimed in claim 1, wherein said first modular element includes an upright, or a longitudinal bar, having two, or three, or four longitudinal grooves for receiving corresponding slides in a free coupling.

8. A device as claimed in claim 1, wherein said second modular element, carried by said slide, includes an upright, or a longitudinal bar.

9. A device as claimed in claim 1, wherein said longitudinal groove has an isosceles trapezium-like cross-section with open shorter base, with said slide being guided along the longer base of said isosceles trapezium.
